(19) United States
(12) Patent Application Publication
(10) Pub. No.: US 2007/0213464 A1
(43) Pub. Date: Sep. 13, 2007

(54) Thermally crosslinked acrylate hotmelts with organic fillers

(75) Inventors: Stephan Zollner, Buchholz/Nordheide (DE); Sven Hansen, Hamburg (DE); Kay Brandes, Kaltenkirchen-Moorkaten (DE); Klaus Massow, Hamburg (DE)

Correspondence Address: Norris, McLaughlin & Marcus P.A.;18th Floor, 875 Third Avenue, New York, NY, 10022, US

(73) Assignee: tesa Aktiengesellschaft, Hamburg (DE)

(21) Appl. No.: 11/433,255

(22) Filed: May 12, 2006

(30) Foreign Application Priority Data
Mar. 8, 2006 (DE) 10 2006 011 113.3

(51) Int. Cl. C08L 33/04; C09J 133/06; B32B 27/30

(52) U.S. Cl. 525/118; 156/332; 156/327

(57) ABSTRACT

A pressure-sensitive adhesive comprising organic fillers, obtainable by a process in which a thermal crosslinker is added in the melt to a polyacrylate copolymer (“polyacrylate”) based on acrylic esters and/or methacrylic esters, at least a fraction of which contains primary hydroxyl groups, at least one organic filler has been or is added to the polyacrylate, the polyacrylate provided with the crosslinker and the filler is conveyed to a coating unit, where it is applied to a web-form coat of a further material and, following application, is homogeneously crosslinked, a process as outlined above, and adhesive tapes furnished with the pressure-sensitive adhesive.

The invention relates to polyacrylates crosslinked by thermal treatment and containing fillers, to a process for preparing them and to their use.

The technological operation of preparing pressure-sensitive adhesives (PSAs) is subject to continual ongoing development. In the industry, hotmelt processes with solventless coating technology are of growing importance in the preparation of PSAs. This development is being forced further forward by ever more stringent environmental regulations and increasing prices for solvents. Consequently there is a desire to eliminate solvents as far as possible from the manufacturing operation for PSA tapes. The introduction of the hotmelt technology is imposing growing requirements on the adhesives. Acrylate PSAs in particular are a subject of very intensive investigation aimed at improvements. For high-level industrial applications, polyacrylates are preferred on account of their transparency and weathering stability. As well as these advantages, however, the acrylate PSAs must also meet stringent requirements in respect of shear strength. This is achieved by means of polyacrylates of high molecular weight and high polarity, with efficient crosslinking. Efficient crosslinking is obtained most easily by means of metal chelates, which at elevated temperatures react with carboxylic acid functions and so crosslink the acrylate PSA. This method is state of the art for solventbome PSAs.

For hotmelt operations preference is given to electron beam curing (EB curing or EBC) since it enables even fairly thick coats to be crosslinked. Electron beam curing requires no thermal energy, and crosslinking takes place in a relatively short time.

EB-curing polyacrylate hotmelts were first described long ago. U.S. Pat. No. 5,194,455, for example, described the addition of N-tert-butylacrylamide monomer in order to force forward the EB curing.

A general disadvantage of EBC is the backing damage. The electron beams penetrate not only the adhesive but also the backing material or the release paper. This results in damage, which is manifested in instances of discoloration or in high unwind forces for the adhesive tape. The need is therefore for a hotmelt PSA crosslinking method which is both gentle to the backing and efficient.

For some time now UV-crosslinkable hotmelt PSAs have been available commercially under the trade name acResin®. These compositions, by virtue of their relatively low weight-average molecular weight (M_{w} of about 200 000-300 000 g/mol), have very good coating qualities and can be crosslinked subsequently by means of UV irradiation. Disadvantages, however, are the inhomogeneity of crosslinking because of a dose profile, low efficiency in the case of resin-modified acrylate compositions, and a limitation of coat thickness to well below 100 μm, thereby ruling out their use for substantial areas of industrial adhesive tapes.

It is also proposed that reactive groups be protected and then liberated only after the coating operation, by means of a mechanism in the presence of crosslinkers such as polyfunctional isocyanates or epoxides, and hence that crosslinking be carried out. An example of this kind of crosslinking, carried out by means of UV initiation with the aid of a photoacid generator, is the application EP 1 127 907 A2. A disadvantage of this process is the liberation of the protective group: in this specific case, the liberation of gaseous isobutene.

Direct thermal crosslinking of acrylate hotmelt compositions containing NCO-reactive groups is described in EP 0 752 435 A1. The blocking-agent-free isocyanates used, particularly sterically hindered and dimerized isocyanates, require very drastic crosslinking conditions, and so a rational industrial implementation is not possible. The procedure described in EP 0 752 435 A1, and of the kind of conditions that prevail when processing from the melt, leads to a rapidly, relatively extensive crosslinking, which makes it difficult to process the composition, particularly in respect of the coating of backing materials. In particular it is impossible to obtain the kind of highly homogeneous adhesive coats that are needed for numerous industrial adhesive-tape applications.

Also state of the art is the use of blocked isocyanates. A disadvantage of this concept is the liberation of blocking groups or fragments, which have an adverse effect on the technical adhesive properties. An example is U.S. Pat. No. 4,524,104. It describes acrylate hotmelt PSAs which can be crosslinked with blocked polyisocyanates together with cycloamidines or salts thereof as catalyst. With this system, one factor is that the catalyst required, but in particular the resultant HCN, phenol, caprolactam or the like, can severely impair the product's properties. Another factor affecting this concept is the drastic conditions required to liberate the reactive groups. No significant deployment of the product has yet been disclosed, and such deployment would anyway seem unattractive.

To set application-compatible properties it is possible to modify. PSAs by admixing tackifier resins, plasticizers, crosslinkers or fillers.

Fillers are used in order, for example, to raise the cohesion of a PSA. Frequently a combination of filler/filler interactions and filler/polymer interactions results in the desired strengthening of the polymer matrix. An increase in cohesion on the basis thereof constitutes a further physical variety of crosslinking.

For fillers which are cited in respect of a reinforcing effect in PSAs, mention is made in particular of the class of the pyrogenic silicas. They are used, among other things, as thickening, gelling or thixotropic agents in a very wide variety of fluids, the effect exploited being that of their influence on the rheological properties of the fluids. Depending on the objective, therefore, it is advantageous to use hydrophilic or hydrophobic silica. Examples of further cohesion-enhancing fillers for improving product properties are modified phyllosilicates.

Fillers are also admixed for increasing weight and/or volume in paper, plastics, adhesives and paints, and other products. Adding filler often improves the industrial usefulness of the products and has influence on their quality, e.g., strength, hardness, etc. The natural, organic and inorganic fillers, such as calcium carbonate, kaolin, talc, dolomite, and the like, are produced mechanically.

In the case of rubber and synthetic elastomers as well it is possible to use appropriate fillers to improve the quality in accordance with the importance of, for example, hardness, strength, elasticity, and extension. Widely used fillers include carbonates, especially calcium carbonate, and silicates (talc, clay, mica), siliceous earth, calcium sulfate, barium sulfate, aluminum hydroxide, glass fibers and glass beads, and also cellulose powders and carbon blacks.

Organic and inorganic fillers can also be differentiated in accordance with their density. For instance, the inorganic fillers often used in plastics and adhesives as well, such as chalk, titanium dioxide, calcium sulfate, and barium sulfate, raise the density of the composition, since they themselves have a density higher than that of the polymer. For a given coat thickness, the weight per unit area is then higher.

In addition there are fillers which can reduce the overall density of the composition. These include hollow microspheres, very bulky lightweight fillers. The spheres are filled with air, nitrogen or carbon dioxide, with the shells of the spheres being composed of glass or else, for certain products, of a thermoplastic.

In addition there are polymeric fillers with a density within the order of magnitude of that of the PSA polymer. This class includes, for example, polyethylene, polypropylene, polyamide, polyacrylonitrile, polyesters, polymethacrylate, and polyacrylate.

It is an object of the invention to provide an acrylate-based pressure-sensitive adhesive which has been blended with fillers, in particular with a high fraction of fillers, and which nevertheless, when coated onto a substrate, has a highly uniform and homogeneous coat appearance. There is a particular desire for mixing with fillers which represent an alternative to the artificial polymeric fillers and which are readily obtainable and, even when added in high fractions, cause as little alteration as possible to the properties of the PSA, such as bond strength and density, in relation to the unblended PSA.

This object is achieved by means of a PSA in which fillers added comprise renewable raw materials, the PSA being obtainable by a process in which a solvent-free functionalized acrylate copolymer, which following metered addition of a thermally reactive crosslinker has a processing time which is sufficiently long for compounding, conveying, and coating, is coated, preferably by means of a roll process, onto a web-form layer of a further material, in particular a tapelike backing material or a layer of adhesive, and which, after having been coated, undergoes aftercrosslinking under mild conditions until a level of cohesion sufficient for PSA tapes is attained.

The invention accordingly provides a pressure-sensitive adhesive comprising organic fillers, obtainable by a process in which a polyacrylate copolymer (referred to below simply as “polyacrylate”) based on acrylic esters and/or methacrylic esters is admixed in the melt with at least one thermal crosslinker, the polyacrylate provided with the crosslinker being conveyed to a coating unit, where it is coated onto a web-form coat of a further material, in particular a tapelike backing material or a layer of adhesive, the crosslinking of the polyacrylate taking place on the web-form layer of the further material, and the polyacrylate having been admixed with the organic fillers identified above. In accordance with the invention a portion of the acrylic esters and/or methacrylic esters contains primary hydroxyl groups. In accordance with the invention, preferably, the thermal crosslinker is added in an extruder.

The invention further provides a process which represents a practical concept for the thermal crosslinking of acrylate hotmelt PSAs in the presence of organic fillers, such as wood flours in particular. The concept consists in a substantially solvent-free functionalized acrylate copolymer to which the fillers have been admixed preferably by compounding. Following the metered addition of a thermally reactive crosslinker, the acrylate copolymer has a processing time which is sufficiently long for compounding, conveying, and coating, can be coated onto tapelike backing material preferably by means of a roller process, and, after coating, undergoes after crosslinking under mild conditions until a level of cohesion sufficient for PSAs is attained.

Adhesive tapes for the purposes of the invention are to comprehend all single- or double-sidedly adhesive-coated sheetlike or tapelike backing structures, thus including not only conventional tapes but also labels, sections, diecuts (sheetlike backing structures coated with adhesive and punch-cut), two-dimensionally extended structures (e.g., sheets), and the like.

Organic fillers which can be used include in particular both vegetable and/or animal raw materials. Very preferably the organic fillers are in finely divided form, especially in fiber, coarse-ground, dust or flour form.

Organic vegetable fillers chosen are preferably renewable raw materials (renewable organic materials), especially wood, cork, hemp, flax, grasses, reed, straw, hay, cereal, maize, nuts or constituents of the aforementioned materials, such as shells (nutshells, for example), kernels, awns or the like. Those employed in particular include wood flours, cork flours, cereal flours, maize flours and/or potato flours, without wishing their enumeration to impose any unnecessary restriction on the inventive teaching.

Organic animal fillers employed include, in particular and with advantage, bones, chitin (e.g., crustacean shells, insect shells), hairs, bristles, and horn, especially in finely divided (ground) form.

Fillers which have emerged as being particularly advantageous are those in which the size of at least 99% of the particles (the size is the diameter in the case of virtually round particles, such as granular particles, or the maximum length in the case of elongate particles, such as fibers, for example) is not more than 1000 μm.

With preference it is possible to use fillers, for example, with one of the following size distributions, a commercially available example being cited in each case but without wishing thereby to impose any unnecessary restriction.

1.) Fillers, e.g., Wood Flours, Having the Following Grain/Fiber Size Distribution:

Not more than 5% above 1000 μm; at least 90% not above 800 μm, at least 50% not above 500 μm, at least 2.5% not above 200 μm.

Commercially available example: wood flour type WF 4063 from Holzmuhle Westerkamp GmbH, Germany; pure softwood, structure: fibrous/granular, moisture content: 8±2%, color: pale yellow, sieve analysis (Retsch laboratory sieve) gave the following grain/fiber size distribution:

>1000 μm-1%

>800 μm-7%

>500 μm-35%

>200 μm-52%

<200 μm-5%

2.) Fillers, e.g., Wood Flours, Having the Following Grain/Fiber Size Distribution:

Maximum size 800 μm; at least 55% not above 500 μm, at least 1% not above 200 μm. Commercially available example: wood flour type WF 8040 from Holzmühle Westerkamp GmbH, Germany; pure softwood, structure: fibrous/granular, moisture content: 10±2%, color: pale yellow, sieve analysis (Retsch laboratory sieve) gave the following grain/fiber size distribution:

| | |
|---|---|
| >1000 μm: | 0% |
| >800 μm: | 0% |
| >500 μm: | 40% |
| >200 μm: | 58% |
| <200 μm: | 2% |

It is particularly preferred if at least 80% of the filler particles have a size—as defined above—of less than 200 μm.

Particular advantage is possessed by fillers having the following size distribution, with a commercial example being cited again without restriction.

3.) Fillers, e.g., Wood Flours, Having the Following Grain/Fiber Size Distribution:

Maximum size 280 μm; at least 90% not above 200 μm, at least 65% not above 160 μm, at least 20% not above 80 μm.

Commercially available example: wood flour type C 120 from Holzmühle Westerkamp GmbH, Germany; pure softwood, structure: fibrous/granular, moisture content: 5±2%, color: grayish yellow, sieve analysis (Retsch laboratory sieve) gave the following grain/fiber size distribution:

| | |
|---|---|
| >280 μm: | 0% |
| >200 μm: | 5.6% |
| >160 μm: | 23.5% |
| >80 μm: | 48.5% |
| <80 μm: | 22.4% |

It is very particularly preferred if at least 75% of the filler particles have a size—as defined above—of less than 200 μm, in particular of less than 100 μm, and it is even more advantageous if, furthermore, at least 50% of the filler particles have a size of less than 80 μm; for example, advantageously, fillers having the following size distribution. Here again a commercially available example is cited, but without wishing thereby to impose any unnecessary restriction.

4.) Fillers, e.g., Wood Flours, Having the Following Grain/Fiber Size Distribution:

Maximum size 200 μm; at least 95% not above 200 μm, at least 75% not above 100 μm, at least 50% not above 80 μm.

Commercially available example: wood flour type C 160 from Holzmühle Westerkamp GmbH, Germany; pure softwood, structure: fibrous/granular, moisture content: 5±2%, color: pale yellow, sieve analysis (Retsch laboratory sieve) gave the following grain/fiber size distribution:

| | |
|---|---|
| >200 μm: | 0% |
| >160 μm: | 2% |
| >100 μm: | 20% |
| >80 μm: | 25% |
| <80 μm: | 53% |

The fraction of the organic fillers in the PSAs is advantageously up to 40%, in particular 1% to 30%, especially 10% to 25%, better still 12% to 20% by weight.

The fillers are especially advantageous when, following their admixture to the polyacrylate, there is no significant change in the density of the resulting PSA, based on the same amount of a corresponding PSA without fillers. The resulting, filled PSA advantageously has a density of 0.9 kg/cm³ to 1.2 kg/cm³.

Organic fillers used with particular advantage are with particular preference those from the group of the aforementioned fillers whose bulk densities are situated in the range from 0.05 kg/cm³ to 0.25 kg/cm³, preferably from 0.08 kg/cm³ to 0.15 kg/cm³.

Organic fillers have typically hygroscopic properties and therefore frequently, depending on the surrounding conditions, possess a certain moisture content. The organic fillers preferably have a moisture content of not more 10%, in particular not more than 7%, especially not more than 5% (all figures within the error margin of ±2%). In a very preferred procedure the fillers are further dried before being mixed into the PSA, in order to reduce the moisture content still further, and are added in the (largely) dry state (less than 2%).

In one very advantageous embodiment the added thermal crosslinker is an isocyanate, preferably a trimerized isocyanate. With particular preference the trimerized isocyanates are aliphatic isocyanates or isocyanates deactivated with amines.

Suitable isocyanates are, in particular, trimerized derivatives of MDI [4,4-methylene-di(phenyl isocyanate)], HDI [hexamethylene diisocyanate, 1,6-hexylene diisocyanate] and/or IPDI [isophorone diisocyanate, 5-isocyanato-1-isocyanatomethyl-1,3,3-trimethylcyclohexane], examples being the Desmodur® grades N3600 and XP2410 (each from BAYER AG: aliphatic polyisocyanates, low-viscosity HDI trimers). Also very suitable is the surface-deactivated dispersion of micronized trimerized IPDI BUEJ 339®, now HF9® (BAYER AG).

Also suitable in principle for crosslinking, however, are other isocyanates such as Desmodur VL 50 (MDI-based polyisocyanates, Bayer AG), Basonat F200WD (aliphatic polyisocyanate, BASF AG), Basonat HW100 (water-emulsifiable polyfunctional isocyanate based on HDI, BASF AG), Basonat HA 300 (allophanate-modified polyisocyanate based on HDI isocyanurate, BASF) or Bayhydur VPLS2150/1 (hydrophilically modified IPDI, Bayer AG), this enumeration not being conclusive.

With further advantage it is possible to use as the thermal crosslinker an epoxide, particularly a polyfunctional epoxide. To accelerate the epoxide crosslinking it is possible in an advantageous procedure to add substances that are known to the skilled worker; the Lewis acids, for example.

Organic renewable raw materials are typically composed to a large extent of cellular tissue and naturally of a relatively high proportion of substances with numerous hydroxyl groups, as indicated below merely by way of example with reference to a number of the compounds stated as being advantageous. Similar comments apply to the other specified organic raw materials and their constituents.

Chitin is a colorless polysaccharide comprising amino sugars and is composed of chains of β-1,4-glycosidically linked N-acetyl-D-glucosamine (NAG) residues. They can be regarded as a cellulose derivative.

The individual constituents of bones are water (approximately 25 percent) and organic substances (principally the protein ossein). Additionally bones include a fraction of inorganic minerals.

Wood is a natural material composed of 40% to 50% cellulose, 20% to 30% wood polysaccharide (hemicellulose), and 20% to 30% lignin. Depending on the variety of wood there are 2% to 6% further constituents present. Cork is a natural material composed of 30% to 56% acids, especially hydroxy fatty acids and hydroxy benzoic acids, 5% to 15% waxes, 2% to 5% cellulose, and 13% to 18% by weight lignin. Further constituents of cork are tannins, fats, mineral oil substances, and the like. Lignin is an aromatic compound of high molecular mass which leads to the lignification of the cell membranes. It can be considered a high molecular mass derivative of phenyl propane, and contains a considerable number of hydroxyl groups. With regard to the more detailed structure of lignin, refer to Roempp Online, Version 2.9, document identifier RD-12-01138 (Georg Thieme Verlag).

The presence of highly hydroxyl-containing substances as constituents of the organic fillers in the presence of thermal crosslinkers which, however, have been regarded as highly problematic by the skilled worker.

Entirely unexpectedly for the skilled worker, therefore, and surprisingly, it has emerged that the blending of polyacrylates comprising thermal crosslinkers with wood or other organic fillers cited within the present specification, and the further processing of these polyacrylates, lead to PSAs which meet the profile of requirements specified as the object.

Instead, the skilled worker would have distanced himself or herself from the admixing of organic fillers (especially in sizeable proportions) that have hydroxyl-containing constituents, since the corresponding hydroxyl-containing constituents, such as lignin or chitin, for example, result in introduction of hydroxyl groups into the PSA. As a result of the hydroxyl groups, in conjunction with the thermal crosslinkers present, isocyanates for example, there would have been an expectation that uncontrolled competing reactions would occur, such as transesterification reactions, for example. The expectation would have therefore been that the hydroxyl groups would therefore deleteriously disrupt the crosslinking technique in the hotmelt (in the melt).

Through transesterification reactions, particularly at the high temperatures prevailing in the hotmelt operation, the skilled worker would have expected a considerable proportion of the ester groups to have undergone substitution by hydroxyl groups. As a result of the hydroxyl groups then incorporated in the polyacrylate, there would be uncontrolled competing crosslinking reactions and hence gelling of the PSA and degradation reactions in the course of thermal storage of the PSAs.

These putative side reactions, particularly the gelling of the PSAs, would have lead to inhomogeneities (local regions of high crosslinking in the composition), meaning that uniform, homogeneous coating would no longer have been possible.

Surprisingly, however, it emerged that the expected side reactions do not occur, or at least not to any considerable extent. Instead, a homogeneous, uniform PSA is produced which retains almost all of the positive qualities of the unfilled composition. Consequently, by means of cheap, readily available fillers, it has been possible to substitute some of the pressure-sensitive adhesive, without the substituted product having distinct disadvantages relative to its unsubstituted counterpart.

With regard to the preparation of the PSA of the invention, the starting point is a polyacrylate copolymer (referred to simply as “polyacrylate” below) based on acrylic esters and/or methacrylic esters, at least some of the acrylic esters and/or methacrylic esters containing primary hydroxyl groups. In a preferred procedure the fraction of acrylic and/or methacrylic esters containing primary hydroxyl groups is up to 25% by weight, based on the polyacrylate without organic fillers. It may further be of advantage for the polyacrylate partly to contain copolymerized acrylic acid.

In particular it is preferred to use a polyacrylate which can be traced back to the following mixture of reactants containing monomers of the following composition:
a1) acrylic and/or methacrylic esters of the following formula:
   CH₂═CH(R^{I})(COOR^{II})
   where R_{I}═H or CH₃ and R^{II} is an alkyl chain having 1 to 20 carbon atoms, with a fraction of 65%-99% by weight,
a2) acrylates and/or methacrylates whose alcohol component contains at least one primary hydroxyl group, and/or vinyl compounds which are copolymerizable with acrylates and contain at least one primary hydroxyl group, with a fraction of 1% to 20% by weight,
a3) and, if the fractions of a1) and a2) do not add up to 100% by weight, olefinically unsaturated monomers containing functional groups, with a fraction of 0% to 15% by weight.

The monomers are preferably chosen such that the resulting polymers can be used at room temperature as PSAs, especially such that the resulting polymers possess PSA properties as set out in the “Handbook of Pressure Sensitive Adhesive Technology” by Donatas Satas (van Nostrand, N.Y. 1989, pages 444-514).

The monomers are preferably chosen such that the resulting polymers have a glass transition temperature, T_{g}, ≦25° C., in the sense of a dynamic glass transition temperature for amorphous systems and of the melting temperature for semicrystalline systems, that can be determined by means of dynamic-mechanical analysis (DMA) at low frequencies.

In order to obtain a polymer glass transition temperature T_{g} preferable for PSAs, viz. T_{g}≦25° C., and in accordance with the above remarks, the monomers are very preferably selected, and the quantitative composition of the monomer mixture advantageously chosen, such as to result in the desired T_{g} value for the polymer in accordance with an equation (E1) analogous to the Fox equation (cf. T. G. Fox, Bull. Am. Phys. Soc. 1 (1956) 123).

$$\frac{1}{{T}_{G}} = {\sum }_{n} \frac{{w}_{n}}{{T}_{G , n}} \qquad ( G1 )$$

In this equation n represents the serial number of the monomers used, wₙ the mass fraction of the respective monomer n (% by weight) and T_{g,n} the respective glass transition temperature of the homopolymer of the respective monomer n, in K.

Great preference is given to using for a1) acrylic or methacrylic monomers composed of acrylic and methacrylic esters having alkyl groups of 1 to 20 carbon atoms, preferably 4 to 9 carbon atoms. Specific examples, without wishing to be restricted by this recitation, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate and isooctyl methacrylate, for example. Further classes of compound to be used for a1) are monofunctional acrylates and/or methacrylates of bridged cycloalkyl alcohols, composed of at least 6 carbon atoms. The cycloalkyl alcohols may also be substituted, for example by C-1-6 alkyl groups, halogen atoms or cyano groups. Specific examples are cyclohexyl methacrylates, isobornyl acrylate, isobornyl methacrylates and 3,5-dimethyladamantyl acrylate.

Great preference is given to using for a2) monomers which contain hydroxyl groups, very preferably primary hydroxyl groups. Examples of a2) are hydroxyethyl acrylate, hydroxyethyl methacrylate, hydroxypropyl acrylate, hydroxypropyl methacrylate, 6-hydroxyhexyl methacrylate, 4-hydroxystyrene and allyl alcohol, this enumeration not being conclusive.

Monomers for a3) are, for example, olefinically unsaturated monomers containing functional groups such as carboxylic acid groups, acid anhydride groups, phosphonic acid groups, amide or imide or amino groups, isocyanate groups, epoxy groups or thiol groups.

Specific examples of a3) are acrylic acid or methacrylic acid, maleic anhydride, itaconic anhydride, itaconic acid, glyceridyl methacrylate, glyceryl methacrylate, vinylacetic acid, β-acryloyloxypropionic acid, trichloroacrylic acid, fumaric acid, crotonic acid, aconitic acid, acrylonitrile, dimethylacrylic acid, N,N-dialkyl-substituted amides, such as N,N-dimethylacrylamide, N,N-dimethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylol-methacrylamide, N-(butoxymethyl)methacrylamide, N-methylolacrylamide, N-(ethoxymethyl)acrylamide and N-isopropylacrylamide, this enumeration not being conclusive.

Particularly suitable polyacrylates are those which are prepared by bulk, solution or emulsion polymerization and may subsequently—particularly if they contain volatile constituents—be concentrated.

In one preferred procedure the polyacrylates have a weight-average molecular weight M_{w} of at least 300 000 g/mol up to a maximum of 1 500 000 g/mol. The average molecular weight is determined by size exclusion chromatography (GPC) or matrix-assisted laser desorption/ionization mass spectrometry (MALDI-MS). The polyacrylates include at least one comonomer containing one or more primary hydroxyl groups. It may be necessary to carry out the polymerization in the presence of polymerization regulators such as thiols, halogen compounds and especially alcohols (isopropanol) in order to set the desired weight-average molecular weight M_{w}.

Also particularly suitable are polyacrylates which have a narrow molecular weight distribution (polydispersity <4). These compositions, with a relatively low molecular weight, have particular shear strength after crosslinking. Since, in comparison to a normally distributed polyacrylate, a narrowly distributed polyacrylate requires a lower molecular weight for a given level of cohesion, the viscosity and operating temperatures are reduced. Thus a narrowly distributed polyacrylate allows a particularly long processing time.

Narrowly distributed polyacrylates can be prepared by means of anionic polymerization or by means of controlled radical polymerization methods, the latter being especially suitable. Examples are described in U.S. Pat. No. 6,765,078 B2 and DE 10036901 A1 or US 2004/0092685 A1. Atom transfer radical polymerization (ATRP) as well can be used advantageously for synthesizing narrowly distributed polyacrylates, using as initiator preferably monofunctional or difunctional secondary or tertiary halides and, to extract the halide(s), complexes of Cu, Ni, Fe, Pd, Pt, Ru, Os, Rh, Co, Ir, Ag or Au (EP 0 824 111 A1; EP 826 698 A1; EP 824 110 A1; EP841 346 A1; EP 850 957 A1). The various possibilities of ATRP are further described in publications U.S. Pat. No. 5,945,491 A, U.S. Pat. No. 5,854,364 A and U.S. Pat. No. 5,789,487 A.

It can be very advantageous for the PSAs of the invention to be resin-free. Optionally, however, it is also possible to add the customary tackifying resins to the polyacrylate in the melt or even before concentration in solution. Tackifying resins for addition that can be used include, without exception, all of the tackifier resins that are known and are described in the literature. Representatives that may be mentioned include pinene resins, indene resins and rosins, their disproportionated, hydrogenated, polymerized and/or esterified derivatives and salts, the aliphatic and aromatic hydrocarbon resins, terpene resins and terpene-phenolic resins, and also C₅, C₉ and other hydrocarbon resins. Any desired combinations of these and further resins can be used in order to adjust the properties of the resultant adhesive in accordance with what is desired. With particular advantage it is possible to use any resins which are compatible with (soluble in) the corresponding polyacrylate; reference may be made in particular to all aliphatic, aromatic and alkylaromatic hydrocarbon resins, hydrocarbon resins based on single monomers, hydrogenated hydrocarbon resins, functional hydrocarbon resins, and natural resins. A preferred terpene-phenolic resin is for example Dertophene T 110, a preferred hydrogenated rosin derivative Foral 85.

Optionally it is also possible for pulverulent and granular fillers, dyes and pigments, including particularly those which are abrasive and provide reinforcement, such as chalks (CaCO₃), titanium dioxides, zinc oxides and carbon blacks, for example, even in high proportions, in other words from 1% to 50% by weight, based on the overall formula, to be metered outstandingly into the polyacrylate melt, incorporated homogeneously and coated.

With particular preference various forms of chalk can be used as a further filler, particular preference being given to using Mikrosöhl chalk (from Söhide). At preferred proportions of up to 30% by weight the addition of filler causes no decisive alterations in the technical adhesive properties (instantaneous bond strength on steel) and in some cases indeed results surprisingly in improvements (room temperature shear strength).

Additionally it is possible for fillers of low flammability, such as ammonium polyphosphate, and also electrically conductive fillers, such as conductive carbon black, carbon fibers and/or silver-coated beads, and also ferromagnetic additives, such as iron(III) oxides, and also additives for producing foamed coats, such as expandants, solid glass beads, hollow glass beads, expandable microballoons, aging inhibitors, light stabilizers, and ozone protectants, for example, to be added or compounded in before or after the concentration of the polyacrylate.

Foaming by means of expandable microballoons or expandants can take place prior to coating, in the extruder, or after coating, on the web. It can be advantageous to smooth the foamed layer, by means of rollers or release paper, for example.

An optional possibility is to add the customary plasticizers in concentrations of up to 5% by weight. Plasticizers which can be metered in include, for example, low molecular weight polyacrylates, phthalates, water-soluble plasticizers, plasticizer resins, phosphates or polyphosphates.

Optionally it can be of advantage to subject the thermally crosslinked layer to radiation-chemical buffer crosslinking. This purpose is served particularly appropriately by electron beam crosslinking.

As a further option the thermally crosslinkable acrylate hotmelt can also be blended with other polymers. Polymers suitable for this purpose include those based on natural rubber, synthetic rubber, EPA, silicone rubber, acrylic rubber, and polyvinyl ether.

It proves advantageous in this context to add these polymers in granulated or otherwise comminuted form to the acrylic hotmelt prior to the addition of the thermal crosslinker. The polymer blend is produced in an extruder, preferably in a multi-screw extruder or in a planetary roller mixer. To stabilize the thermally crosslinked acrylate hotmelts, and also, in particular, the polymer blends composed of thermally crosslinked acrylate hotmelt and other polymers, it can be sensible to subject the shapingly applied material to low doses of electron beams. For this purpose, optionally, crosslinking promoters such as di-, tri- or polyfunctional acrylate and/or polyester, or urethane acrylate, can be added to the polyacrylate.

The invention further provides the process for preparing the pressure-sensitive adhesive of the invention and for producing adhesive tapes furnished with the pressure-sensitive adhesive of the invention.

The polymerization of the polyacrylate copolymers (“polyacrylates”) takes place in accordance with the polymerization processes that are familiar to the skilled worker, and may be effected in solution or else in the melt.

It is possible to employ ionic and, with particular preference, radical polymerization processes.

The polymerization time, especially in solution, amounts to between two 2 and 72 hours, depending on conversion and temperature.

In the case of polymerization in the melt, the solution is subsequently concentrated. The residual solvent content after concentration is very advantageously not more than 1% by weight, in particular not more than 0.3% by weight, based on the polyacrylate.

In the process of the invention for preparing crosslinked polyacrylate PSAs in accordance with the present invention, the organic fillers can be added before or after the concentration operation, with particular advantage by means of compounding. Following concentration, i.e. in the melt, the reactive crosslinkers are added to the polyacrylate that is to be crosslinked preferably under precise temperature and time control. The composition is conveyed to a coating unit and transferred to a backing, preferably by means of 2-roll, multiple-roll or nozzle coating.

The time from the metered addition of the crosslinking system in the compounding apparatus to the shaping application of the composition to a backing is called the processing time. Within this time the PSA now crosslinking can be coated in a gel-free manner with a visually good coat appearance. Crosslinking then takes place predominantly after coating on the web under mild conditions, which damage neither backing nor liner.

The addition and incorporation of the thermally reactive crosslinking system into the polyacrylate matrix take place in the sense of the invention and with particular advantage in continuously operating compounding apparatus. This apparatus is designed in accordance with the invention so as to ensure, with thorough mixing in conjunction with a low input of shearing energy, that the residence time of the composition after the metered addition of the crosslinking system is short. The compounding apparatus preferably comprises twin-screw extruders and/or planetary roller extruders. It is especially advantageous if the spindles of the extruder can be heated and/or cooled.

The crosslinkers are added at one or more locations in the apparatus, preferably in unpressurized zones. It is also advantageous if the thermally reactive crosslinker substances are added in finely divided form to the polyacrylate, in the form for example of an aerosol, in fine droplets, or diluted in a suitable diluent such as a polymer-compatible plasticizer.

A preferred procedure is to use the thermal crosslinker, in particular the trimerized isocyanate, at 0.1% to 5% by weight, in particular at 0.2% to 1% by weight, based on the polyacrylate.

In the case of one development of the process of the invention the temperature of the polyacrylate when the thermal crosslinker is added is between 60° C. and 120° C., more preferably between 70° C. and 100° C.

The residual monomer content of the polyacrylate when the thermal crosslinker is added is advantageously not more than 1% by weight, in particular not more than 0.3% by weight, based on the polyacrylate. With further advantage the residual solvent content of the polyacrylate when the thermal crosslinker is added is not more than 1% by weight, in particular not more than 0.3% by weight, based on the polyacrylate.

In the inventive sense it is possible with advantage to combine the addition of the fillers, the crosslinkers, and, where appropriate, further additives, so that the resin and the wood flour and/or the fillers described are incorporated jointly into the polymer matrix.

It is also possible to realize the admixtures in a single extruder or in extruder lines, so that, starting from the solventborne base polymer at the exit of the extruder or extruder line, without additional production steps, the ready-compounded, substantially solvent-free, resin-, filler-, and crosslinker-blended self-adhesive composition of the invention is obtained, and is then passed on for coating.

As mentioned earlier on above, the time between metered addition of the crosslinking system and visually homogeneous shaping application of the composition onto a backing or between two backings is referred to as the processing time. The processing time is heavily dependent on the operating temperature, roll surface temperatures, type and amount of crosslinker, and on the functionalization of the acrylate composition with carboxyl and hydroxyl groups, and indicates the time period within which the adhesive/crosslinker blend can be coated with a visually good coating appearance (gel-free, speck-free).

The polyacrylate provided with the crosslinker is conveyed to a coating unit, with particular preference with an extruder, more preferably still with the compounding extruder, in which the filler and/or the crosslinker have already been added and in which, where appropriate, the concentration of the polyacrylate has already taken place. It is advantageous in accordance with the invention, therefore, to carry out the concentration of the polyacrylate, the addition and compounding of filler, the addition and compounding of crosslinker, and the transportation of the composition in a single extruder or in extruder lines, so that, starting from the solventborne base polymer at the exit of the extruder or extruder line, without additional production steps, the ready-compounded, substantially solvent-free, resin-, filler-, and crosslinker-blended self-adhesive composition of the invention is obtained and then is passed on for coating.

For the coating stage, the polyacrylate composition is transferred to a backing material, preferably by means of roll applicator units (coating calenders). The coating calenders may consist of two, three or more rolls. A further possibility is that of nozzle coating. Low-viscosity systems are coated preferably using nozzles, higher-viscosity systems using multiple-roll units.

Coating for the purposes of this invention refers to the shaping application of the crosslinker-blended, very substantially solvent-free adhesive in thin coats and to a web-form backing material. The processing time is generally 3 to 30 minutes, preferably 5 to 20 minutes, more preferably 5 to 10 minutes.

As backing material, for adhesive tapes for example, it is possible in this context to use the materials that are customary and familiar to the skilled worker, such as films (polyesters, PET, PE, PP, BOPP, PVC), nonwovens, woven fabrics, and woven films, and/or, where appropriate, release paper. This enumeration is not intended to be conclusive.

The backing in this case may be a permanent backing (particularly for the production of backing-based adhesive tapes) or a temporary backing (particularly for the production of adhesive transfer tapes).

The self-adhesive compositions are coated preferably using roll applicator units, also called coating calenders. The coating calenders may be composed advantageously of two, three, four or more rolls.

Advantageously at least one of the rolls is provided with an antiadhesive roll surface, preferably all rolls which come into contact with polyacrylate. In a favorable procedure it is possible to make all of the rolls of the calenders antiadhesive.

As the antiadhesive roll surface it is particularly preferred to use a composite steel/ceramic/silicone material. Roll surfaces of this kind are resistant to thermal and mechanical loads.

The text below describes a variety of inventively suitable embodiments. The indication of coating processes is not, however, intended to restrict the invention unnecessarily.

Directly after coating by means of roll application or extrusion die, the adhesive has only a low level of incipient crosslinking, but is not yet sufficiently crosslinked. The crosslinking reaction proceeds advantageously on the backing.

The reaction, particularly with isocyanates, proceeds preferably without catalysis. The crosslinking reaction proceeds to completion under standard conditions (room tem-perature) even without supply of heat. Generally speaking, after a storage period of up to 14 days, in particular from four to ten days, the crosslinking reaction with the polyfunctionalized isocyanate is substantially at an end and the ultimate cohesion of the composition is attained.

As a result of the crosslinking with isocyanates, urethane groups are formed which link the polymer chains. This linkage raises the cohesion of the adhesive and hence also its shear strength. These groups, as is known, are very stable. This permits self-adhesive tapes which are very aging-stable and heat-resistant.

In the case of functionalized acrylate copolymers containing no copolymerized acrylic acid the reaction proceeds preferably at slightly elevated temperatures with aromatic and/or aliphatic isocyanates.

In the case of functionalized acrylate copolymers which contain copolymerized acrylic acid the reaction rate is faster. In this case an operationally stable process is accomplished preferably with the slower aliphatic isocyanates or surface-deactivated iso-cyanate emulsions.

The physical properties of the end product, particularly its viscosity, bond strength and contact adhesion (tack), can be influenced by the degree of crosslinking, so that through a suitable choice of reaction conditions it is possible to optimize the end product. A variety of factors determine the operating window of this process. The most important influencing variables are operating temperature and coating temperature, residence time in compounding extruder and coating apparatus, type of crosslinker (deactivated, aliphatic, aromatic), crosslinker concentration, fraction of hydroxyl groups in the polymer, fraction of copolymerized acid groups in the polymer, and average molecular weight of the polyacrylate.

A number of relations are described below with regard to the preparation of the self-adhesive composition of the invention, these relations optimizing the preparation process but not being restrictive of the concept of the invention.

For a given concentration of crosslinker, an increase in the operating temperature leads to a reduced viscosity, which enhances the coatability of the composition but reduces the processing time. An increase in processing time is obtained by lowering the crosslinker concentration, lowering the molecular weight, lowering the concentration of hydroxyl groups in the polymer, lowering the fraction of acid in the polymer, using less reactive isocyanates and lowering the operating temperature. An improvement in the cohesion of the composition can be obtained in different ways. One way is to raise the crosslinker concentration, which reduces the processing time. With the crosslinker concentration constant, it is also possible to raise the molecular weight of the polyacrylate, which is possibly more efficient. The abovementioned parameters must be adapted appropriately in accordance with the desired profile of requirements of the composition and/or the product.

The polyacrylate to be prepared by the process of the invention is used in particular as a pressure-sensitive adhesive (PSA), in particular as a PSA for an adhesive tape, the acrylate PSA being present as a single-side or double-side film on a backing sheet. Moreover, the polyacrylate can be used as a viscoelastic backing for single-sidedly or double-sidedly adhesive-coated tapes. In that case the viscoelastic backing primarily forms the middle layer of adhesive tapes having a three-layer construction.

The invention hence also provides single-sided or double-sided adhesive tapes which are furnished with one or—in the case of double-sided adhesive tapes—with one or two coats of the filled, especially wood flour-filled, PSA of the invention. Further provided by the invention are the unbacked PSA coats themselves (particularly in the sense of unbacked adhesive tapes; adhesive transfer tapes).

This process is also especially suitable for producing three-dimensional shaped structures with or without PSA properties. A particular advantage of this process is that there is no limit on the coat thickness of the polyacrylate to be crosslinked and shapingly applied, in contrast to UV and EBC curing processes. In accordance with the choice of the coating or shaping application apparatus, therefore, it is possible to produce structures of any desired shape, which are then able to aftercrosslink to a desired strength under mild conditions.

This process is also particularly suitable for producing particularly thick coats, especially pressure-sensitive adhesive coats or viscoelastic acrylate coats having a thickness of more than 80 μm. Coats of this kind are difficult to produce using the solvent technology (formation of bubbles, very slow coating speed, lamination of thin coats one atop another is costly and inconvenient and represents a hidden weak point).

The invention also provides pressure-sensitive adhesive coats and backing materials coated on one or both sides with pressure-sensitive adhesive coats (adhesive tapes) where the coat thickness of the pressure-sensitive adhesive coat is at least 80 μm, preferably at least 100 μm, more preferably at least 200 μm.

Thick pressure-sensitive adhesive coats may be present in unfilled, all-acrylate form or resin-blended form or filled with organic or inorganic fillers. Also possible are layers with open-cell or closed-cell foaming in accordance with the known techniques. Possible methods of foaming include foaming by way of compressed gases such as nitrogen or CO₂, or foaming by way of expandants such as hydrazines or expandable microballoons. Where expanding microballoons are used, the composition or the shapingly applied coat is advantageously activated in an appropriate manner by introduction of heat. Foaming can be carried out in an extruder or after coating. It can be advantageous to smooth the foamed layer by means of appropriate rollers or release films. To produce coats that are analogous to foamed coats, it is also possible to add hollow glass spheres or pre-expanded polymeric microballoons to the thermally crosslinked acrylate hotmelt PSA.

In particular it is also possible with this process to produce thick layers which can be used as a backing layer of double-sidedly PSA-coated adhesive tapes, with particular preference filled and foamed layers which can be utilized as backing coats for foamlike adhesive tapes. With these coats as well it is sensible to add solid glass spheres, hollow glass spheres or expanding microballoons to the polyacrylate before the thermal crosslinker is added. Where expanding microballoons are used the composition and/or the shapingly applied coat is activated in an appropriate manner by introduction of heat. Foaming can take place in the extruder or after coating. It can be advantageous to smooth the foamed layer by means of suitable rollers or release films or by the laminated application of a pressure-sensitive adhesive coated onto a release material. A foamlike viscoelastic coat of this kind can have a pressure-sensitive adhesive coat laminated onto at least one side of it. Preferably a Corona-pretreated polyacrylate coat is laminated onto both sides. Alternatively, differently pretreated adhesive layers, i.e., pressure-sensitive adhesive layers and/or heat-activable layers based on polymers with other than an acrylate bases, can be laminated onto the viscoelastic coat. Suitable base polymers are adhesives based on natural rubber, synthetic rubbers, acrylate block copolymers, styrene block copolymers, EVA, certain polyolefins, specific polyurethanes, polyvinyl ethers, and silicones. Preference is given, however, to compositions which contain no notable fraction of migratable constituents, whose compatibility with the polyacrylate is so good that diffusion takes place in significant amount into the acrylate layer, where the properties are altered.

Instead of laminating a PSA coat on both sides, it is also possible to use, on at least one side, a hotmelt adhesive coat or thermally activable adhesive coat. Asymmetric adhesive tapes of this kind permit the bonding of critical substrates with a high bond strength.

Where the thermally crosslinked acrylate hotmelt coat is used as a viscoelastic backing coat, the glass transition range of the polyacrylate may also lie above +25° C. Depending on the fraction of hardening comonomers, such as tert-butyl acrylate, isobornyl acrylate or styrene, for example, a T_{g} of up to 80° C. is possible.

Further suitable fillers for a thermally crosslinked acrylate hotmelt coat, which is used as a viscoelastic backing, are hydrophilic or hydrophobic silica gels such as Aerosils or Ultrasils, inorganic fillers such as chalk, titanium dioxide, calcium sulfate, and barium sulfate, and also organic fillers such as polymer beads or fibers based on cellulose, polyethylene, polypropylene, polyamide, polyacrylonitrile, polyester, polymethacrylate and/or polyacrylate.

As further hardening comonomers it is also possible for macromonomers to have been copolymerized into the polyacrylate. Particularly suitable macromonomers are those as described in EP 1361260 B1, such as 2-polystyrene-ethyl methacrylate having a molecular weight Mw of 13000 g/mol. These macromonomer-modified thermally crosslinked acrylate hotmelts can be used as a PSA or else as a viscoelastic backing.

For certain applications the adhesive tape of the invention, in that case as an intermediate, can be further improved or adapted to the requirements by means of additional irradiation using actinic radiation (UV light or electron beams, for example).

### EXAMPLES

The exemplary experiments which follow are intended to illustrate the invention without the choice of the examples given being intended to restrict the invention unnecessarily.

Test Methods

Solids Content:

The solids content is a measure of the fraction of non-volatiles in a polymer solution. It is determined gravimetrically by weighing the solution, then evaporating the volatile fractions in a drying cabinet at 120° C. for 2 hours, and weighing the residue again.

K value (According to FIKENTSCHER):

The K value is a measure of the average size of molecules of high polymer compounds. It is measured by preparing one percent (1 g/100 ml) toluene solutions of polymer and determining the kinematic viscosities using a VOGEL-OSSAG viscometer. Standardizing to the viscosity of the toluene gives the relative viscosity, from which the K value can be calculated by the method of Fikentscher (Polymer 8/1967, 381 ff.).

Gel Permeation Chromatography GPC

The average molecular weight M_{w} and the polydispersity PD were determined by means of gel permeation chromatography on a 100 μl sample subjected to clarifying filtration (sample concentration: 4 g/l). The eluent used was tetrahydrofuran containing 0.1% by volume trifluoroacetic acid. Measurement was made at 25° C. The precolumn used was of type PSS-SDV, 5μ, 10³ Å, ID 8.0 mm×50 mm. Separation was carried out using the columns of type PSS-SDV, 5μ, 10³ Å and also 10⁵ Å and 10⁶ Å each of ID 8.0 mm×300 mm (columns from Polymer Standards Service; detection by means of Shodex R171 differential refractometer). The flow rate was 1.0 ml per minute. Calibration was carried out against PMMA standards (polymethyl methacrylate calibration).

180° Bond Strength Test

The sample for analysis was a standard polyester backing 23 μm thick coated on one side with the self-adhesive composition under investigation (self-adhesive composition coatweight as indicated in the tables).

A 20 mm wide strip of the adhesive tape sample was applied to steel plates. The steel plates were washed twice with acetone and once with isopropanol. The PSA strip was pressed onto the substrate twice using a 2 kg weight. The adhesive tape was then immediately peeled from the substrate at 300 mm/min and an angle of 180°. The results are reported in N/cm and are averaged from three measurements. All measurements were conducted at room temperature.

The bond strength on polyethylene (PE) was determined analogously. The defined adhesion substrate (bond-strength plate) used was a polyethylene plate which had been produced as a test plate by injection molding from Basell Hostalen GC7260 HDPE pellets. Prior to measurement, this plate was cleaned with ethanol. A strip of the coated standard polyester backing 20 mm wide was pressed under load (2 kg) onto the adhesion substrate. Immediately thereafter the adhesive tape was peeled from the substrate at a speed of 300 mm/min and an angle of 180°, and the force required to achieve this at room temperature was measured. The measurement (in N/cm) resulted as the average value from three individual measurements. To calibrate the measurement technique, a commercial test adhesive tape for testing nonadhesive coatings (tesa 7475 from tesa AG; specification bond strength on steel: 31.25 N/25 mm) was investigated in accordance with this measurement technique; the bond strength found in the course of this measurement on the polyethylene test plate was 4.5 N/cm.

Holding Power

The sample for analysis was a standard polyester backing 23 μm thick coated on one side with the self-adhesive composition under investigation (self-adhesive composition coatweight as indicated in the tables).

A strip of the adhesive tape, 13 mm wide, was applied to a smooth steel surface cleaned three times with acetone and once with isopropanol. The area of application was 20 mm* 13 mm (length*width). Subsequently, with a pressure applied by a weight of 2 kg, the adhesive tape was pressed four times onto the steel support. At room temperature a 1 kg weight was fixed to the adhesive tape. The measured shear withstand times are reported as holding power in minutes and correspond to the average of three measurements. Measurement is carried out under standard conditions (23° C., 55% atmospheric humidity) and at 70° C. in a heat cabinet.

Preparation of the Base Polymers for the Examples

The preparation of the starting polymers is described below. The polymers investigated are prepared conventionally by free radical polymerization in solution.

HEMA=hydroxyethyl methacrylate

AIBN=2,2′-azobis(2-methylbutyronitrile)

Perkadox 16=bis(4-t-butylcyclohexyl) peroxodicarbonate

Base Polymer 1

A reactor conventional for radical polymerizations was charged with 27 kg of 2-ethylhexyl acrylate, 27.0 kg of n-butyl acrylate, 4.8 kg of methyl acrylate, 0.6 kg of acrylic acid and 0.6 kg of HEMA in 40 kg of acetone/isopropanol (92.5:7.5). After nitrogen gas had been passed through the reactor for 45 minutes with stirring the reactor was heated to 58° C. and 30 g of AIBN were added. Subsequently the external heating bath was heated to 75° C. and the reaction was carried out constantly at this external temperature. After 1 h a further 30 g of AIBN were added and after 4 h the batch was diluted with 10 kg of acetone/isopropanol mixture (92.5:7.5).

After 5 h and after 7 h, reinitiation was carried out with 90 g of Perkadox 16 on each occasion. After a reaction time of 22 h the polymerization was discontinued and the product cooled to room temperature. The polyacrylate has a K value of 78, a solids content of 54.6% and an average molecular weight of M_{w}=810 000 g/mol, polydispersity (M_{w}/Mₙ)=7.3

Method 1: Concentration/Preparation of Hotmelt PSA:

The acrylate copolymers functionalized with hydroxyl groups (base polymers) are freed very substantially from solvent by means of a BERSTORFF single-screw extruder (concentration extruder). The concentration parameters are exemplified here with reference to base polymer 1. The speed of the screw was 170 rpm, the motor current 17 A, and a throughput of 62.3 kg liquid/h was realized. For concentration a vacuum was applied at 3 different domes. The underpressures were 340 mbar, 50 mbar and 7 mbar respectively, with the lowest vacuum being applied in the first dome. The exit temperature of the concentrated hotmelt was 105° C. The solids content after this concentration step was 99.7%.

Method 2: Preparation of Resin-Modified Hotmelt PSA

The acrylate hotmelt PSAs prepared by method 1 set out above were conveyed directly into a downstream WELDING twin-screw extruder (WELDING Engineers, Orlando, USA; model 30 MM DWD; screw diameter 30 mm, length of screw 1=1258 mm; length of screw 2=1081 mm; 3 zones). A solids metering system was used to meter 30% by weight of the resin Dertophene T110 (manufactured by DRT, France) into zone 1, and it was mixed in homogeneously. The parameters for resin compounding are exemplified here by reference to base polymer 1. The speed was 474 rpm, the motor current 44 A, and a throughput of 31.3 kg/h was realized. The temperatures of zones 1 and 2 were each 100° C., the melt temperature in zone 1112° C. and the temperature of the composition on exit (zone 3) 90° C.

Method 3: Preparation of the Filter-Modified Self-Adhesives, Blending with the Thermal Crosslinker

The acrylate hotmelt PSAs prepared in accordance with methods 1-2 were melted in a feeder extruder (single-screw conveying extruder from TROESTER) and conveyed therewith as a polymer melt into a twin-screw extruder (LEISTRITZ, Germany, ref. LSM 30/34). The apparatus is electrically heated from outside and air-cooled by a variety of fans. The mixing-screw geometry is chosen so that effective distribution of the wood flour and the crosslinking system in the polymer matrix is accompanied by the assurance of a short residence time of the adhesive in the extruder. For this purpose the mixing screws of the twin-screw extruder were arranged so that conveying elements are in alternation with mixing elements. The fillers or wood flour and the respective crosslinking system are added by means of suitable metering equipment, at two or more sites where appropriate, into the unpressurized conveying zones of the twin-screw extruder. The crosslinking system was metered using, where appropriate, metering aids. Where appropriate it is possible to connect a vacuum pump to the twin-screw extruder in order to free the compounded self-adhesive composition from gas inclusions. The ready-compounded adhesive is then supplied, by means of a melt pump downstream of the mixing extruder, to a distributor nozzle that conveys the adhesive into the first roll nip.

Depending on the intended use of the adhesive tape, different grades of fillers and wood flours/ground woods were used. The listing below shows details of some varieties of trialed ground woods from Holzmühle Westerkamp GmbH, Germany.

Type C 160

pure softwood, structure: granular/fibrous, moisture content: 5±2%, color: pale yellow,
sieve analysis (Retsch laboratory sieve): grain/fiber size distribution:
   >200 μm-0%
   >160 μm-2%
   >100 μm-20%
   >80 μm-25%
   <80 μm-53%
      Type C 120
pure softwood, structure: granular/fibrous, moisture content: 5±2%, color: grayish,
sieve analysis (Retsch laboratory sieve): grain/fiber size distribution:
   >280 m-0%>
   >200 μm-5.6%
   >160 μm-23.5%
   >80 μm-48.5%
   <80 μm-22.4%
      Type WF 8040
pure softwood, structure: granular/fibrous, moisture content: 10±2%, color: pale yellow,
sieve analysis (Retsch laboratory sieve): grain/fiber size distribution:
   >1000 μm-0%
   >800 μm-0%
   >500 μm-40%
   >200 μm-58%
   <200 μm-2%
      Type WF 4063
pure softwood, structure: granular/fibrous, moisture content: 8±2%, color: pale yellow,
sieve analysis (Retsch laboratory sieve): grain/fiber size distribution:
   >1000 m-1%
   >800 μm-7%
   >500 μm-35%
   >200 μm-52%
   <200 μm-5%
      Before being admixed to the base polymer (see examples H1 to H7) the wood fillers were dried in a forced-air oven at 115° C. under otherwise standard conditions for 20 to 30 minutes until they exhibited a good free-flowing behavior.

Coating of the self-adhesive compositions of the invention is accomplished by means of 2- or 3-roll calenders in accordance with one of the methods described below.

The text below presents specific examples relating to the preparation of self-adhesive compositions and coating of the adhesive tapes of the invention, without any intention that the invention should be unnecessarily restricted as a result of the choice of indicated formulations, configurations, and operating parameters.

### Examples H1 to H₄

Base polymer 1 was concentrated by method 1 (solids content 99.7%) and then blended by method 2 with 30% by weight of Dertophene T 110 resin. This resin-modified acrylate hotmelt was compounded by method 3 with different amounts of dried wood flour of type C 120 (Holzmühle Westerkamp, Germany) and together with 0.96% by weight in each case (based on acrylate copolymer) of the hydrophilic, aliphatic polyisocyanate Bayhydur VP LS 2150/1 (Bayer MaterialScience) in the twin extruder described. To improve its meterability the trimerized diisocyanate was diluted in a ratio of 1 to 3 with the liquid phosphate ester Reofos 65 (Great Lakes, USA). The processing time of the compounds is greater than 5 minutes in each case for an effective exit temperature of 85° C. (examples H1—without wood flour) to 125° C. (example H4-29% wood flour) after exiting the Leistritz extruder. Coating takes place on a 2-roll applicator (method 4.A) with roll surface temperatures of 100° C. and coatweights of 278 to 390 g/m² onto PET film 23 μm thick. Further details and also operating parameters relating to the production are found in Table T1.

Bond strength measurements on steel and polyethylene (PE) substrates, and tests for determining the holding powers at room temperature, were carried out on the adhesive tape produced. The results of the technical adhesive investigations of examples H1 to H4 are summarized in Table T2. Remarkable, and unexpected for the skilled worker, is the fact that the technical adhesive characteristics of the adhesive tape filled with 17% by weight of wood flour (example H2) are virtually identical to those of the unfilled specimen (example H1) (for details see Table T2).

### Examples H5 to H7

Base polymer 1 was concentrated by method 1 (solids content 99.7%) and then blended by method 2 with 30% by weight of Dertophene T 110 resin. This resin-modified acrylate hotmelt was compounded by method 3 with different amounts of dried wood flour of type C 160 (Holzmuhle Westerkamp, Germany) together with 0.29% or 0.30% (based on acrylate copolymer) of the trimerized aliphatic polyisocyanate Desmodur XP 2410, Bayer MaterialScience, Germany, in the twin-screw extruder described. To improve its meterability the trimerized diisocyanate was diluted in a ratio of 1 to 4 with the liquid phosphate ester Reofos 65 (Great Lakes, USA). The processing time of the compounds is in each case greater than 7 minutes at melt temperatures, after exiting the Leistritz extruder, at approximately 100° C.

Coating takes place using a 3-roll calender (method 4.B) whose middle roll is provided with an antiadhesive surface of type AST 9984-B from Advanced Surface Technologies, Germany and whose roll 1 is provided with the antiadhesive surface of type Pallas SK-B-012/5 from Pallas Oberflächentechnik GMBH, Germany. The external diameters of the first two rolls are each 300 mm, the external diameter of the third calendar roll 250 mm. The temperatures of the first two rolls were set at 100° C., that of the third roll at 50° C. The temperature of the distributor nozzle is 100° C. At belt speeds of up to 280 m/min and coatweights of 83 g/m² and 97 g/m², the coating of the self-adhesive composition takes place in accordance with example H5 onto siliconized release paper (glassine paper), after which the self-adhesive composition is laminated by a prior-art method onto a PET film 23 μm thick. In accordance with examples H6 and H7 the self-adhesive compositions are coated directly onto the 23 μm PET film.

Further details of the formulations, production parameters, and coating are found in Table T1, while results of the technical adhesive evaluations are given in Table T2.

TABLE T1
Details of the formulations, production parameters, and on coating;
Crosslinkers
BAYHYDUR VP LS 2150/1, BAYER MATERIALSCIENCE, Germany, crosslinker type:
hydrophilic aliphatic polyisocyanate
Desmodur XP2410, BAYER MATERIALSCIENCE, Germany, crosslinker type:
trimerized aliphatic polyisocyanate

| | | | | Incorporation of wood flour and crosslinker, coating | | | |
|---|---|---|---|---|---|---|---|
| | | | | Crosslinker - type | | | Setpoint |
| | Base polymer | | | and amount | Mass | Speed | temperature |
| | Base | K | Fillers fraction | [% crosslinker | throughput | of TSE | TSE |
| Example | polymer | value | [% by weight] | based on polymer] | TSE [kg/h] | [1/min] | [° C.] |
| H 1 | Base | 78 | — | 0.96% | 11.0 | 100 | 80 |
| | polymer 1 | | | Bayhydur | | | |
| | | | | VPLS 2150/1 | | | |
| H 2 | Base | 78 | 17% groundwood | 0.96% | 13.0 | 105 | 80 |
| | polymer 1 | | C 120 | Bayhydur | | | |
| | | | | VPLS 2150/1 | | | |
| H 3 | Base | 78 | 23% groundwood | 0.96% | 13.0 | 280 | 80 |
| | polymer 1 | | C 120 | Bayhydur | | | |
| | | | | VPLS 2150/1 | | | |
| H 4 | Base | 78 | 29% groundwood | 0.96% | 13.0 | 280 | 80 |
| | polymer 1 | | C 120 | Bayhydur | | | |
| | | | | VPLS 2150/1 | | | |
| H 5 | Base | 78 | — | 0.15% | 10.5 | 100 | 80 |
| | polymer 1 | | | Desmodur | | | |
| | | | | XP2410 | | | |
| H 6 | Base | 78 | 5% groundwood | 0.15% | 11.5 | 100 | 80 |
| | polymer 1 | | C 160 | Desmodur | | | |
| | | | | XP2410 | | | |
| H 7 | Base | 78 | 10% groundwood | 0.15% | 12.0 | 100 | 80 |
| | polymer 1 | | C 160 | Desmodur | | | |
| | | | | XP2410 | | | |

| | Incorporation of wood flour and crosslinker, coating | | | | | | |
|---|---|---|---|---|---|---|---|
| | Current | | Melt | Coating method, | | | |
| | consumption | Exit | temperature | temperature | Processing | | Coat |
| | TSE | pressure | after TSE | of rolls | time | Coatweight | thickness |
| Example | [A] | TSE [bar] | [° C.] | 1/2/3 [° C.] | [min] | [g/m²] | [μm] |
| H 1 | 14 | 23 | 85 | Method 4.A | >5 | 278 | 280 |
| | | | | 100/100/— | | | |
| H 2 | 14 | 22 | 98 | Method 4.A | >5 | 289 | 287 |
| | | | | 100/100/— | | | |
| H 3 | 14 | 16 | 125 | Method 4.A | >5 | 360 | 356 |
| | | | | 100/100/— | | | |
| H 4 | 14 | 16 | 125 | Method 4.A | >5 | 390 | 393 |
| | | | | 100/100/— | | | |
| H 5 | 13 | 20 | 100 | Method 4.B | >7 | 83 | 83 |
| | | | | 100/100/50 | | | |
| H 6 | 13 | 20 | 95 | Method 4.B | >7 | 89 | 88 |
| | | | | 100/100/50 | | | |
| H 7 | 14 | 21 | 99 | Method 4.B | >7 | 97 | 97 |
| | | | | 100/100/50 | | | |

TSE = Twin-screw extruder

TABLE T2
Formula, product construction, technical adhesive properties of specimens produced

| | | | | | Coat | Bond | Bond | Holding |
|---|---|---|---|---|---|---|---|---|
| | Composition in % by weight | | | | weight | strength | strength PE | power 5 N |
| Example | (Base polymer, fillers, crosslinker) | | | Backing | [g/m²] | steel [N/cm] | [N/cm] | 23° C. [min] |
| H 1 | Base polymer 1 | — | 0.96% | 23 μm | 278 | 9.3 | 3.9 | 4560 |
| | | | Bayhydur | polyester film | | | | |
| | | | VPLS 2150/1 | | | | | |
| H 2 | Base polymer 1 | 17% groundwood | 0.96% | 23 μm | 289 | 9.1 | 3.8 | 990 |
| | | C 120 | Bayhydur | polyester film | | | | |
| | | | VPLS 2150/1 | | | | | |
| H 3 | Base polymer 1 | 23% groundwood | 0.96% | 23 μm | 360 | 8.3 | 1.1 | 1260 |
| | | C 120 | Bayhydur | polyester film | | | | |
| | | | VPLS 2150/1 | | | | | |
| H 4 | Base polymer 1 | 29% groundwood | 0.96% | 23 μm | 390 | 3.2 | 0.6 | 210 |
| | | C 120 | Bayhydur | polyester film | | | | |
| | | | VPLS 2150/1 | | | | | |
| H 5 | Base polymer 1 | — | 0.15% Desmodur | 23 μm | 83 | 10.6 | 5.2 | 2980 |
| | | | XP2410 | polyester film | | | | |
| H 6 | Base polymer 1 | 5% groundwood | 0.15% Desmodur | 23 μm | 89 | 10.5 | 4.9 | 2100 |
| | | C 160 | XP2410 | polyester film | | | | |
| H 7 | Base polymer 1 | 10% groundwood | 0.15% Desmodur | 23 μm | 97 | 10.4 | 5.1 | 1080 |
| | | C 160 | XP2410 | polyester film | | | | |

TABLE T3
Mass weight (MA) of specimens produced in comparison to
coat thickness

| | | | | % by |
|---|---|---|---|---|
| | | Thickness | Density | weight of |
| Example | MA [g/m²] | [μm] | [g/cm³] | wood |
| H 1 | 278 | 280 | 0.99 | 0 |
| H 2 | 289 | 287 | 1.01 | 17 |
| H 3 | 360 | 356 | 1.01 | 23 |
| H 4 | 390 | 393 | 0.99 | 29 |
| H 5 | 83 | 83 | 1.00 | 0 |
| H 6 | 89 | 88 | 1.01 | 5 |
| H 7 | 97 | 97 | 1.00 | 10 |

Through the pressure-sensitive adhesive of the invention a PSA system is offered which has been outstandingly provided with readily commercially available, favorable fillers, especially wood flours and/or cork flours, without thereby significantly altering the density of the composition, i.e., not least, the weight per unit area in the case of coatings for producing adhesive tapes, as compared with a chemically corresponding PSA to which no such fillers have been added. The technical adhesive properties of the PSA remain largely retained even after the fillers have been admixed. Admixing of the fillers has virtually no effect on the viscosity behavior of the PSA.

The fillers are organic renewable materials which not only in “production” but in also application are a very environmentally friendly material, so that, as compared with PSA products to which chemical additives have been added, these products possess environmental and also health advantages.

The organic fillers, particularly wood and/or cork, offer the advantage of lightness in conjunction with high strength, and are long-lived even under critical climatic conditions. They possess anisotropic properties (in respect of the longitudinal strength and transverse strength, for example).

Entirely unexpectedly for the skilled worker, the fillers can be used for PSAs to which thermal crosslinkers, especially isocyanates and/or epoxides, have been added for the purpose of a gentle crosslinking reaction. Anticipated side reactions, particularly between the organic filler constituents containing hydroxide groups and the thermal crosslinkers, were not observed, and so there is no gelling or degradation reaction on the part of the PSA.

Consequently the PSA of the invention is outstandingly suitable for producing adhesive tapes, since despite the presence of organic fillers it is possible to achieve a very uniform and homogeneous coating pattern.

A particular advantage of the thermally crosslinked acrylate hotmelt coat is that these coats, whether used as viscoelastic backing or as pressure-sensitive adhesive, have the same surface quality that do not exhibit a profile of crosslinking through the coat, in contrast to UV- and UBC-crosslinked coats (homogeneous crosslinking). As a result it is possible via the crosslinking to control and adjust the balance between adhesive and cohesive properties in a way which is ideal for the coat as a whole. With radiation-chemically crosslinked coats, always one side or one part-coat is over- or under-crosslinked.

1. A pressure-sensitive adhesive comprising organic fillers, obtained by
adding a crosslinker to a polyacrylate copolymer (“polyacrylate”) of acrylic esters and/or methacrylic esters, in the melt,
adding at least one filler to the polyacrylate before or after addition of the crosslinker,
conveying the polyacrylate which has been provided with the crosslinker and the filler to a coating unit, and applying it to a web-form coat of a further material and, following application, crosslinking it,
wherein
the crosslinker is a thermal crosslinker,
a fraction of the acrylic esters and/or methacrylic esters contains primary hydroxyl groups, and
the at least one filler is an organic filler.

2. The pressure-sensitive adhesive of claim 1, wherein
the fraction of organic fillers in the adhesive is up to 40% by weight.

3. The pressure-sensitive adhesive as claimed in claim 1, wherein
the organic fillers are renewable raw materials.

4. The pressure-sensitive adhesive as claimed in claim 3, wherein
the organic fillers are selected from the group consisting of wood, cork, hemp, flax, grasses, reed, straw, hay, cereal, maize, and constituents of the aforementioned materials.

5. The pressure-sensitive adhesive of claim 1, wherein
the organic fillers are in the form of finely divided particles.

6. The pressure-sensitive adhesive of claim 5, wherein
the size of at least 99% of the filler particles is not more than 1000 μm, the size being defined as the diameter in the case of virtually round particles or the maximum length in the case of elongate particles.

7. The pressure-sensitive adhesive as claimed in claim 6, wherein
at least 80% of the filler particles have a size of less than 200 μm.

8. A process for preparing a pressure-sensitive adhesive, which comprises
adding a crosslinker to a polyacrylate copolymer (“polyacrylate”) formed of acrylic esters and/or methacrylic esters, in the melt,
adding at least one filler to the polyacrylate before or after addition of the crosslinker,
conveying the polyacrylate which has been provided with the crosslinker and the filler to a coating unit, and applying it to a web-form coat of a further material and, following application, homogeneously crosslinking it,
wherein
the crosslinker is a thermal crosslinker,
a fraction of the acrylic esters and/or methacrylic esters contains primary hydroxyl groups, and
the at least one filler is an organic filler.

9. The process of claim 8, wherein the thermal crosslinker is an isocyanatc.

10. The process of claim 8, wherein the thermal crosslinker is an epoxide.

11. The process of claim 8, wherein
the coating unit is a multiple-roll coating calender having two to four rolls.

12. An adhesive tape having a homogeneously crosslinked polyacrylate coat comprising organic fillers.

13. The adhesive tape of claim 12, furnished on one or both sides with a pressure-sensitive adhesive of claim 1.

14. The pressure sensitive adhesive of claim 2, wherein said amount of organic fillers is from 1 to 40% by weight.

15. The pressure sensitive adhesive of claim 5, wherein said finely divided particles are in the form of fibers, dust or flour.

16. The pressure sensitive adhesive of claim 7, wherein at least 75% of the filler particles have a size of less than 100 μm.

17. The pressure sensitive adhesive of claim 16, wherein at least 50% of the filler particles have a size of less than 80 μm.

18. The process of claim 9, wherein said isocyanate is a trimerized isocyanate.

19. The process of claim 9, wherein said isocyanate is an aliphatic isocyanate.

20. The process of claim 9, wherein said isocyanate is an isocyanate deactivated with amines.

21. The process of claim 10, wherein said epoxide is a polyfunctional epoxide.
